(19) United States
(12) Patent Application Publication
(10) Pub. No.: US 2011/0114843 A1
(43) Pub. Date: May 19, 2011

(54) RADIATION DETECTOR AND METHOD OF USING A RADIATION DETECTOR

(75) Inventors: Michael R. Kusner, Auburn Township, OH (US); Clarisse Tur, Cleveland, OH (US)

(73) Assignee: Saint-Gobain Ceramics & Plastics, Inc., Worcester, MA (US)

(21) Appl. No.: 12/949,721

(22) Filed: Nov. 18, 2010

Related U.S. Application Data
(60) Provisional application No. 61/262,665, filed on Nov. 19, 2009.

(51) Int. Cl. G01T 1/20

(52) U.S. Cl. 250/361 R

(57) ABSTRACT

A radiation detector can include a scintillating material to produce scintillation light in response to receiving neutrons, gamma radiation, potentially other targeted radiation, or any combination thereof. In a particular embodiment, the detector converts scintillating light to an electrical pulse and analyzes the shape of the electrical pulse to determine whether neutrons, gamma rays, or potentially other targeted radiation are detected. The detector can be configured to distinguish between neutrons and gamma rays. The scintillating material can extend over a length greater than approximately 1.1 meters. In an embodiment, the radiation detector can be used near a passageway to detect radioactive material passing through the passageway. More particularly, the radiation detector can be used to detect the radioactive material within a vehicle passing through the passageway.

### CROSS-REFERENCE TO RELATED APPLICATION

This application claims priority under 35 U.S.C. §119(e) to U.S. Patent Application No. 61/262,665 entitled “Radiation Detector and Method of Using a Radiation Detector,” by Kusner et al., filed Nov. 19, 2009, which is assigned to the current assignee hereof and incorporated herein by reference in its entirety.

### FIELD OF THE DISCLOSURE

The present disclosure is directed to radiation detectors and methods of using radiation detectors.

### BACKGROUND

Radiation detectors are used in a variety of industrial applications. For example, scintillators can be used for medical imaging and for well logging in the oil and gas industry. Typically, scintillators have scintillator crystals made of an activated sodium iodide or other material that is effective for detecting gamma rays or neutrons. Generally, the scintillator crystals are enclosed in casings or sleeves that include a window to permit radiation-induced scintillation light to pass out of the crystal package. The light is detected by a light-sensing device, such as a photomultiplier tube (PMT). The PMT can convert the light photons emitted from the crystal into electrical pulses. The electrical pulses are can be processed by associated electronics and may be registered as counts that are transmitted to analyzing equipment.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a particular embodiment of a radiation detector;

FIG. 2 is a block diagram illustrating another particular embodiment of a radiation detector;

FIG. 3 is a plot illustrating particular embodiments of shapes of gamma radiation-induced and neutron-induced electrical pulses;

FIG. 4 is a flow diagram illustrating a particular embodiment of a method of using a radiation detector; and

FIGS. 5-10 are general diagrams illustrating particular embodiments of a radiation detection system.

The use of the same reference symbols in different drawings indicates similar or identical items.

### DETAILED DESCRIPTION

Numerous innovative teachings of the present disclosure will be described with particular reference to exemplary embodiments. However, it should be understood that this class of embodiments provides only a few examples of the many advantageous uses of the innovative teachings herein. In general, statements made in the present disclosure do not necessarily limit any of the various claimed articles, systems, or methods. Moreover, some statements may apply to some inventive features but not to others.

In the description below, a flow-charted technique may be described in a series of sequential actions. The sequence of the actions and the party performing the steps may be freely changed without departing from the scope of the teachings. Actions may be added, deleted, or altered in several ways. Similarly, the actions may be re-ordered or looped. Further, although processes, methods, algorithms or the like may be described in a sequential order, such processes, methods, algorithms, or any combination thereof may be operable to be performed in alternative orders. Further, some actions within a process, method, or algorithm may be performed simultaneously during at least a point in time (e.g., actions performed in parallel) or serially.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

A radiation detector can be characterized as having a length and a width that is substantially perpendicular to and equal to or shorter than the length. When viewing the radiation detector in a direction substantially along a length-wise axis, for example, a top view, the radiation detector may have a circular, ellipsoidal or another shape. A diameter can be a particular type of width. In another embodiment, a width can be a major axis or a minor axis of the ellipse or ellipsoid.

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single device is described herein, more than one device may be used in place of a single device. Similarly, where more than one device is described herein, a single device may be substituted for that one device.

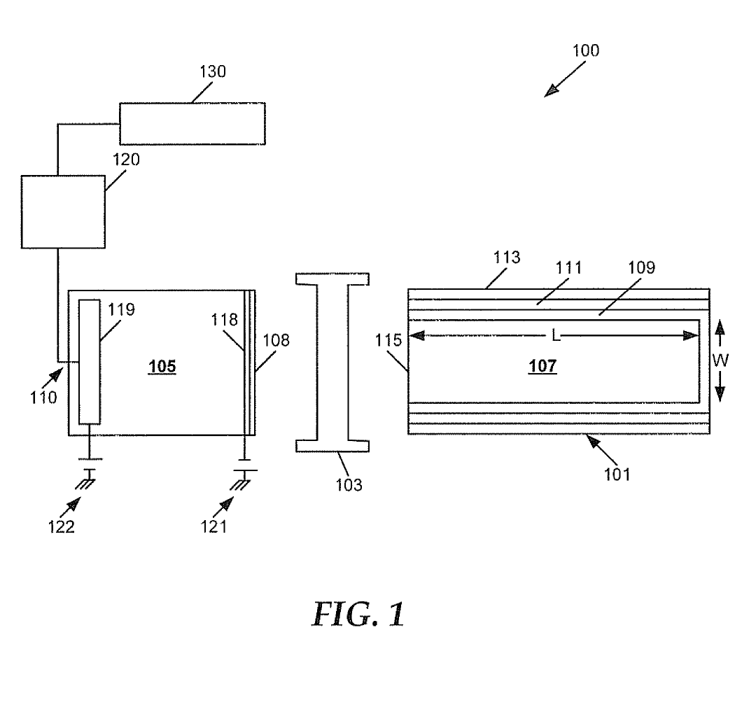

FIG. 1 shows a particular embodiment of a radiation detector 100. The radiation detector 100 can include a scintillator 101 coupled to a photosensor 105. In one embodiment, the radiation detector 100 can include a light pipe 103. Though the scintillator 101, the light pipe 103, and the photosensor 105 are illustrated separate from each other, the scintillator 101 and the photosensor 105 can be coupled to each other directly or via the light pipe 103. In one embodiment, the scintillator 101 and the photosensor 105 can be coupled to the light pipe 103 using an optical gel, bonding agent, fitted structural components, or any combination thereof.

The scintillator 101 can include a scintillating material 107 housed within a casing 113. In a particular embodiment, the scintillating material 107 can have a length, L, of greater than approximately 1.1 meters. For example, the scintillating material can extend greater than 2 meters, such as greater than 3 meters, or another length corresponding to a height of a person, an automobile, a truck or other cargo vehicle, a watercraft, a rail car, or any combination thereof. In another embodiment, the scintillating material 107 can have a width, W, substantially perpendicular to the length, L, where the width is greater than or equal to approximately 0.01 meters. For example, the scintillating material 107 can be a polygon having a width greater than or equal to approximately 0.01 meters. In another example, the scintillating material 107 can be substantially cylindrical and can have a diameter, a particular type of width, greater than or equal to approximately 0.1 meters.

The scintillating material 107 can include a material to detect neutrons, gamma radiation, other targeted radiation or any combination thereof. In an embodiment, the scintillating material 107 can include a plurality of different materials. One of the materials can include ⁶Li or ¹⁰B that produces a secondary particle in response to a neutron. Another material can include a scintillator, such as a solid ZnS material, or a material such as 1,4-diphenylbenzene (“p-Terphenyl”), 2,5-diphenyloxazole (“PPO”), or 1,4-bis(5-phenyloxazol-2-yl) benzene (“POPOP”), that can be mixed into a solvent, such as toluene or another solvent. These scintillators can produce scintillation light in response to the secondary particle. As used herein, ⁶Li and ¹⁰B can refer to ionized or non-ionized forms of ⁶Li and ¹⁰B. In a particular embodiment, another material, such as a lithium nitrate material, a lithium salicylate material, a trimethyl borate material, another material including ⁶Li, another material including ¹⁰B, or any combination thereof, may be included within the medium.

In a particular embodiment, the scintillator may be dispersed within a non-scintillating medium. In an example, the non-scintillating medium can include a liquid or a gel and is hereinafter referred to as a liquid or gel scintillating medium. The scintillator as previously described may be in the form of a powder that is mixed with a liquid or gel. In an illustrative embodiment, the medium can include an organic solvent, such as an aromatic compound. In a particular embodiment, the aromatic compound can be a homoaromatic compound or a heteroaromatic compound. For instance, where p-Terphenyl or PPO is used as a scintillator, the organic solvent can include a 1-phenyl-1-xylyl ethane (PXE) or a linear alkyl benzene (LAB).

In a particular embodiment, a hydrocarbon solvent can be chosen to act as a thermalyzer to slow fast neutrons to speeds compatible with thermal neutron responsive materials including ⁶Li or ¹⁰B. Additionally, an intermediate solvent can be used to facilitate the dissolution of a material including ⁶Li or ¹⁰B in an organic solvent, such as an aromatic solvent. For example, a lithium nitrate material can be dissolved in 2-ethoxyethanol, and the resulting solution can be dissolved in PXE. In another embodiment, a surfactant can be used to allow an aromatic solvent to carry water molecules, such that an aqueous solution of ⁶Li or ¹⁰B in the aromatic solvent can be used. In other embodiments, another compound or substance can be used in place or in conjunction with the materials described herein to achieve a property of the scintillating material 107 as needed or desired. For instance, a wavelength shifting additive can be used.

In another particular embodiment, the medium can include a polymer containing ⁶Li or ¹⁰B. For example, the medium can include polyvinyltoluene, polystyrene or polymethylmethacrylate.

A ¹⁰B concentration within the medium can be from approximately 0.05% by mass to approximately 10% by mass. Alternatively, a ⁶Li concentration within medium can be from approximately 0.05% by mass to approximately 10% by mass. In an embodiment in which p-Terphenyl or PPO is used as a scintillator, the p-Terphenyl or PPO concentration within the non-scintillating medium (such as PXE or LAB) can be from approximately 1% by mass to approximately 5% by mass. Alternatively, polyvinyltoluene or polystyrene can be used in place of PXE or LAB for a solid scintillating material. In an embodiment where ZnS is used as a scintillator, LiF and ZnS can be mixed in powder form and held together by a plastic binder. The plastic content can be less than approximately 10% by mass, for example. In an embodiment in which wavelength shifting is desired, an additive such as 1,4-bis[2-methylstyryl]benzene (“bis MSB”) can be added in an amount from approximately 0.01% by mass to approximately 1% by mass. In an embodiment, any of the scintillating materials described herein may be uniformly mixed with and remain suspended within a medium.

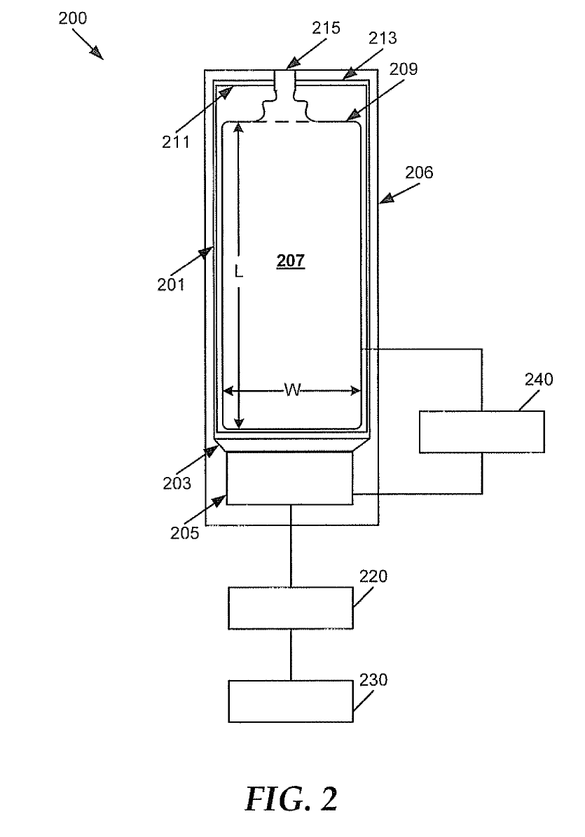

The scintillator 101 can include greater than approximately 11 liters of the scintillating material 107, such as greater than approximately 30 liters or greater than approximately 50 liters. The scintillating material 107 can be contained within a cell, tank, capsule, or other article, or may be a portion of a polymeric composition, which is longer than approximately 1.1 meters. An example of such an article is illustrated in FIG. 2.

In a particular embodiment, the scintillator 101 can be surrounded by a neutron moderator (not shown), such as polyethylene or another material, to convert fast neutrons into thermal neutrons, for which ⁶Li and ¹⁰B have greater cross-sections. The scintillator 101 can also include a reflector 109. In one embodiment, the casing 113 can include a shock-absorbing member 111 disposed between the casing 113 and the reflector 109. Further, the casing 113 can include an output window 115 that is interfaced to an end of the scintillating material 107. The output window 115 can include glass or another transparent or translucent material suitable to allow photons emitted by the scintillator 101 to pass toward the photosensor 105. In an illustrative embodiment, an optical interface, such as clear silicone rubber, can be disposed between the scintillating material 107 and the output window 115. The optical interface can be polarized to align the reflective indices of the scintillating material 107 and the output window 115.

As illustrated, the light pipe 103 can be disposed between the photosensor 105 and the scintillator 101 and can facilitate optical coupling between the photosensor 105 and the scintillator 101. In one embodiment, the light pipe 103 can include a quartz light pipe, plastic light pipe, or another light pipe. In another embodiment, the light pipe 103 can comprise a silicone rubber interface that optically couples an output window 115 of the scintillator 101 with the input 108 of the photosensor 105. In some embodiments, multiple light pipes can be disposed between the photosensor 105 and the scintillator 101.

The photosensor 105 can comprise a photodiode, a photomultiplier tube (PMT), or a hybrid PMT that includes a photocathode and a semiconductor electron sensor. The photosensor 105 can be housed within a tube or housing made of a material capable of protecting electronics associated with the photosensor 105, such as a metal, metal alloy, other material, or any combination thereof.

The photosensor 105 can include an input 108, and an output 110, such as an interface to receive a coaxial cable or other article to transmit electrical signals. The photosensor 105 can receive, via the input 108, light from the scintillator 101, other sources, or a combination thereof. The photosensor 105 can be configured to send electrical pulses from the output 110 to the pulse analyzer 120, in response to light that the photosensor 105 receives. The pulse analyzer 120 and its operation are described in further detail later in this specification. The pulse analyzer 120 can be coupled to a pulse counter 130 that counts photons received at the photosensor 105 based on electrical pulses output by the photosensor 105 to the pulse analyzer 120.

In a particular, illustrative embodiment, the photosensor 105 can be configured to receive light from the scintillator 101 via the input 108. Photons included in the light can strike a photocathode 118 of the photosensor 105 and transfer energy to electrons in a valence band of the photocathode 118. The electrons can become excited until they are emitted as electrons from a surface of the photocathode 118 that is opposite the input 108. In a particular embodiment, the surface of the photocathode 118 can include a layer of electropositive material that can facilitate emission of the electrons from the surface of the photocathode 118.

Electrons emitted by the photocathode 118 can be collected at an anode of the photosensor 105, and an electrical pulse or signal can be sent to the pulse analyzer 120 via the output 110. In an example, a first voltage 121, such as a supply voltage or other voltage, can be applied to the photocathode 118. Electrons emitted from the surface of the photocathode 118 can be accelerated, by the first voltage 121, to strike the surface of an electron detector 119. In addition, a second voltage 122, such as a reverse bias voltage or other voltage, can be applied to the electron detector 119. Energy from electrons entering the electron detector can produce carriers that are removed from the electron detector 119 by the reverse bias voltage 122, creating an electrical pulse.

In a particular embodiment, the photosensor 105 can receive light emitted by the scintillator 101 as a result of the scintillating material 107 receiving gamma radiation, neutrons, other targeted radiation, or any combination thereof. The photosensor 105 can send an electrical pulse to the pulse analyzer 120 after receiving such light. The pulse analyzer 120 can be configured to analyze the electrical pulse and to determine whether the electrical pulse corresponds to a gamma ray-induced electrical pulse or a neutron-induced electrical pulse. The pulse analyzer 120 can send an indicator to the counter 130, where the indicator indicates that the electrical pulse corresponds to a gamma ray-induced electrical pulse or a neutron-induced electrical pulse. In another embodiment, the pulse analyzer 120 can send an indicator to the pulse counter 130 when the electrical pulse received from the photosensor 105 corresponds to a neutron-induced electrical pulse and to not send an indicator to the pulse counter 130 when the electrical pulse received from the photosensor 105 does not correspond to a neutron-induced electrical pulse, such as when the electrical pulse corresponds to a gamma ray-induced electrical pulse or to an electrical pulse caused by shock, vibration, temperature, static discharge, or another non-scintillation event (collectively and individually, a “noise pulse”).

In a particular embodiment, the pulse analyzer 120 can include a module or device, such as a field programmable gate array or other digital or analog circuit to identify an electrical pulse as corresponding to a neutron-induced electrical pulse based on a portion of a shape of the electrical pulse, such as a rise time, a decay time, another portion, or any combination thereof. A rise time can include readings from when the electrical pulse initially exceeds a threshold up to a peak of the electrical pulse. The decay time can include readings from the peak of the electrical pulse to a later time when the electrical pulse is at or below the threshold.

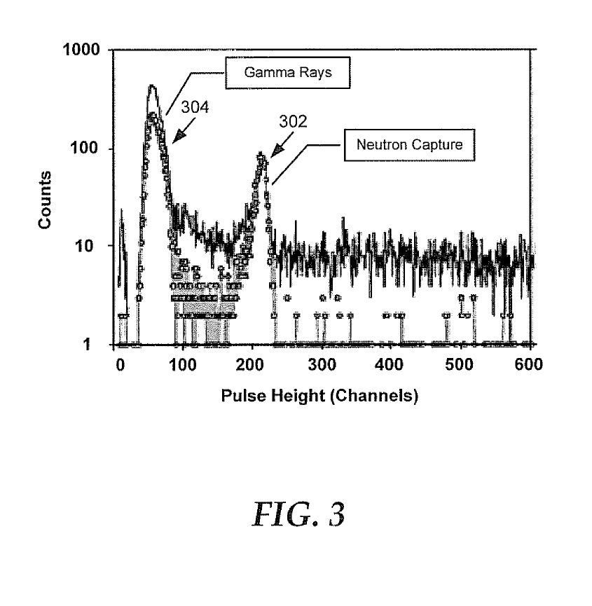

For example, as illustrated in FIG. 3, a neutron-induced electrical pulse 302 emitted by the photosensor 105 can have a shape that includes a slower rise time, a slower decay time, or any combination thereof, as compared to a gamma ray-induced electrical pulse 304. In another embodiment, the shape of a gamma ray-induced electrical pulse can substantially correspond to a Poisson distribution, whereas the shape of the neutron-induced electrical pulse may not.

In another example, the pulse analyzer 120 can identify a neutron-induced electrical pulse based on a full width (or full duration) at a half maximum (FWHM) of the electrical pulse. In a further example, the pulse analyzer 120 can identify a neutron-induced electrical pulse based on 90% of a full range of the electrical pulse.

In still another example, the pulse analyzer 120 can identify a neutron-induced electrical pulse based on an integrated rise time of the electrical pulse. For instance, the integrated rise time of a neutron-induced electrical pulse can be from approximately 658 ns to approximately 1130 ns, whereas the integrated rise time of a gamma ray-induced electrical pulse can be from approximately 590 ns to approximately 680 ns.

In a particular embodiment, the pulse counter 130, the pulse analyzer 120, or another device, can be configured to determine whether a target number of neutron-induced electrical pulses have been sent by the photosensor 105 in a period of time. If so, a radioactive material alert can be activated at an alert system (not shown) that includes or is separate from the pulse counter 130, the pulse analyzer 120, another device, or any combination thereof. For instance, if 2 to 5 neutrons are detected by a radiation detector, or by radiation detectors within a certain distance, over approximately 1 second, then the alert can be activated.

FIG. 2 illustrates another embodiment of a radiation detector. The radiation detector 200 can include a scintillator 201 coupled to a photosensor 205 via a light guide 203. The radiation detector 200 can include a casing 206, such as a metal casing, plastic casing, or other impact resistant casing. The photosensor 205 can also be coupled to a pulse analyzer 220. The pulse analyzer 220 can be coupled to a pulse counter 230.

The scintillator 201 can contain a scintillating material 207 that includes ⁶Li or ¹⁰B. In a particular embodiment, the scintillating material 207 can be contained within a cell 209 or another enclosure to hold a scintillating material that is not a single-phase, single-crystal scintillating material, such as a liquid, polymeric or gel scintillating material. In a particular embodiment, the cell 209 can have a length, L, greater than approximately 1.1 meters, such as greater than 2 meters, greater than 3 meters, or another length corresponding to a height of a person, an automobile, a truck or other cargo vehicle, a watercraft, a rail car, or any combination thereof. Further, the cell 209 can have a width, W, substantially perpendicular to the length, L, where the width is greater than or equal to approximately 0.01 meters. The scintillator 201 can contain greater than approximately 11 liters of the liquid or gel scintillating material, or polymeric composition, such as greater than approximately 20 liters or greater than approximately 40 liters.

In an illustrative embodiment, the cell 209 can include a mechanical portion to decrease a pressure of a liquid or gel scintillating material when the pressure exceeds a target pressure. In a particular embodiment, the mechanical portion can include a bellows 215. In another embodiment, the mechanical portion can include a hydraulic pump, a hydraulic valve, a pressure regulator, another device or any combination thereof, to maintain that scintillating material 207 at a substantially consistent pressure, such that it maintains a substantially uniform composition, similar to a scintillating crystal or other solid scintillating material, at a temperature from approximately −40° C. to approximately +50° C.

In another illustrative embodiment, the radiation detector 200 can include a thermal regulator 240 to measure a temperature of the scintillating material 207 and to increase or reduce the temperature of the scintillating material 207, until the scintillating material 207 is at approximately a target temperature. Further, the thermal regulator 240 can communicate a measured temperature to the photo sensor 205. In a particular embodiment, the photosensor 205 can adjust electrical pulses output to the pulse analyzer 220 according to a calibration table or another calibration system, such that electrical pulses output by the photosensor 205 are substantially consistent and identifiable by the pulse analyzer 220 when the scintillator 201 is at a temperature from approximately −40° C. to approximately +50° C. In a more particular embodiment, a region to be analyzed by the radiation detector 200 can be at a temperature from approximately −40° C. to approximately +50° C. The scintillating material and region can be at substantially the same temperature or at different temperatures.

For instance, if a temperature of the scintillating material 207 drops below the target temperature, it may be desirable to increase the temperature slowly back to the target temperature. By receiving temperature measurements from the thermal regulator 240, the photosensor 205 can calibrate its electrical pulses to reduce peak shift uncertainty, until the scintillating material is at approximately the target temperature. In one example, the electrical pulses output by the photosensor 205 can exhibit a maximum peak shift uncertainty from approximately 0.1% to approximately 4% when the scintillator is at a temperature from approximately −40° C. to approximately +50° C.

The scintillator 201 can also include a reflector 211 to direct scintillation light emitted by the scintillating material 207 toward the photosensor 205 via the light guide 203. In one embodiment, the scintillator 201 can include a casing 216, which may include a shock-absorber 213 to substantially prevent damage to the cell 209 as a result of shock to the casing 216.

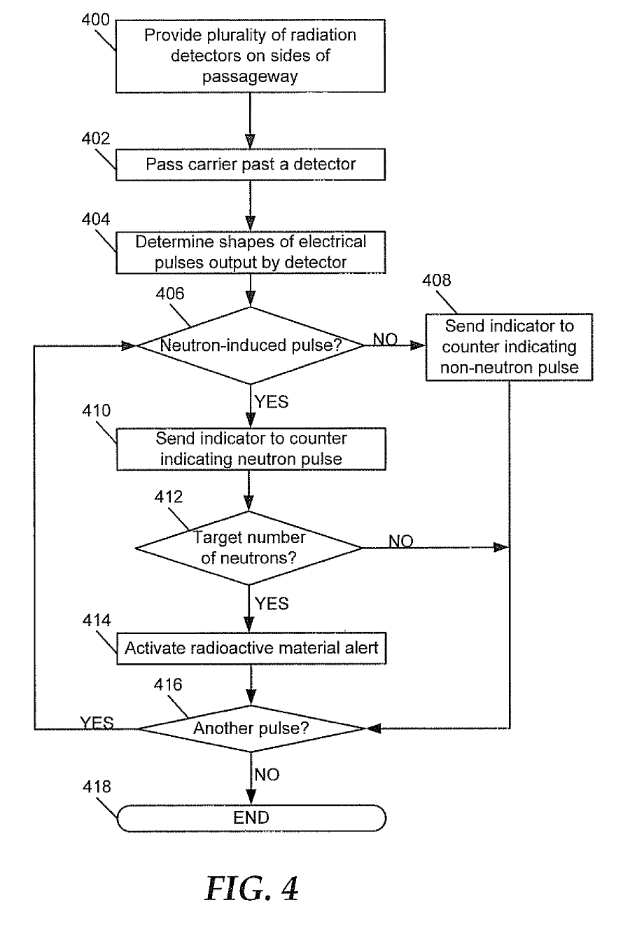

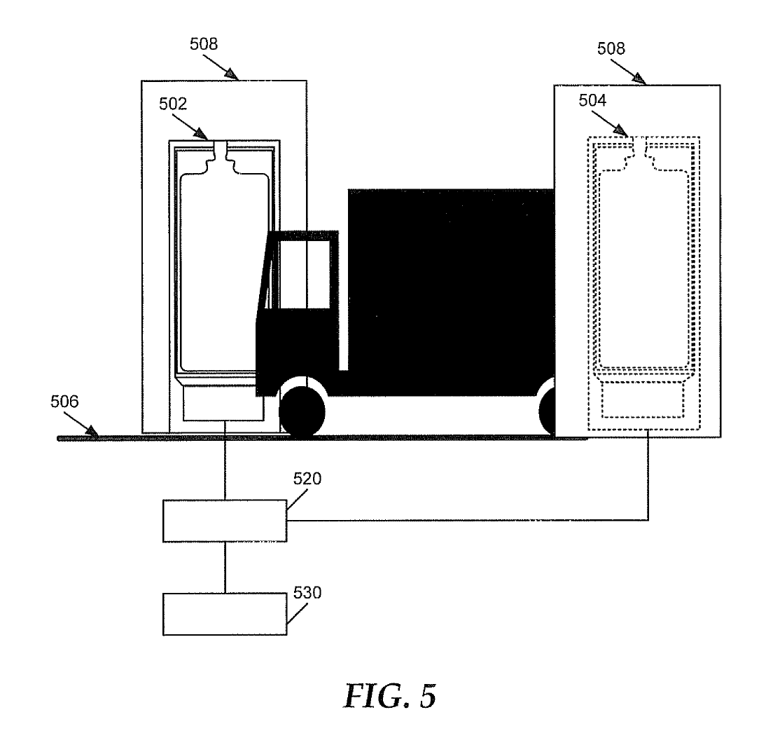

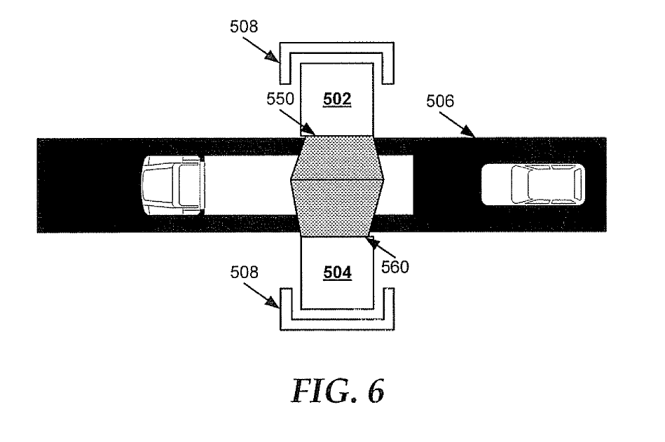

FIG. 4 illustrates a particular embodiment of a method of using a radiation detector. At block 400, a plurality of radiation detectors can be provided on sides of a passageway, such as a road, a sidewalk, a waterway, a railway, or another passageway accessible by a transporter, such as a person, a passenger vehicle, a cargo vehicle, a watercraft, or another transporter. For instance, as illustrated in the side view of FIG. 5, a radiation detector 502 can be provided on a side of a road 506, and another radiation detector 504 can be provided on an opposing side of the road 506, where the side and the opposing side of the road 506 extend substantially perpendicular to the road surface. The radiation detectors 502 and 504 can be staggered. Alternatively, as illustrated in the top view of FIG. 6, the radiation detectors 502 and 504 can be substantially across from each other on opposing sides of the road, such that a detection region 550 of the radiation detector 502 substantially directly faces a detection region 560 of the other radiation detector 504. A detection region can include a volume of space relative to a radiation detector, from which neutrons, gamma radiation, or any combination thereof, can effectively reach the radiation detector. Though the detection regions 550 and 560 are shown relative to a single lane passageway, the radiation detection system can be scaled as needed or desired for an application involving multiple lanes between the radiation detectors 502 and 504.

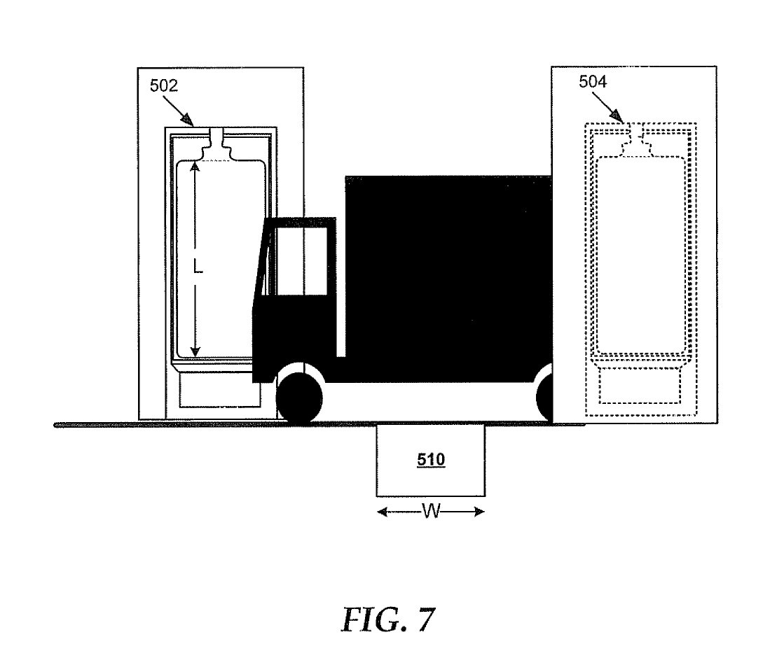

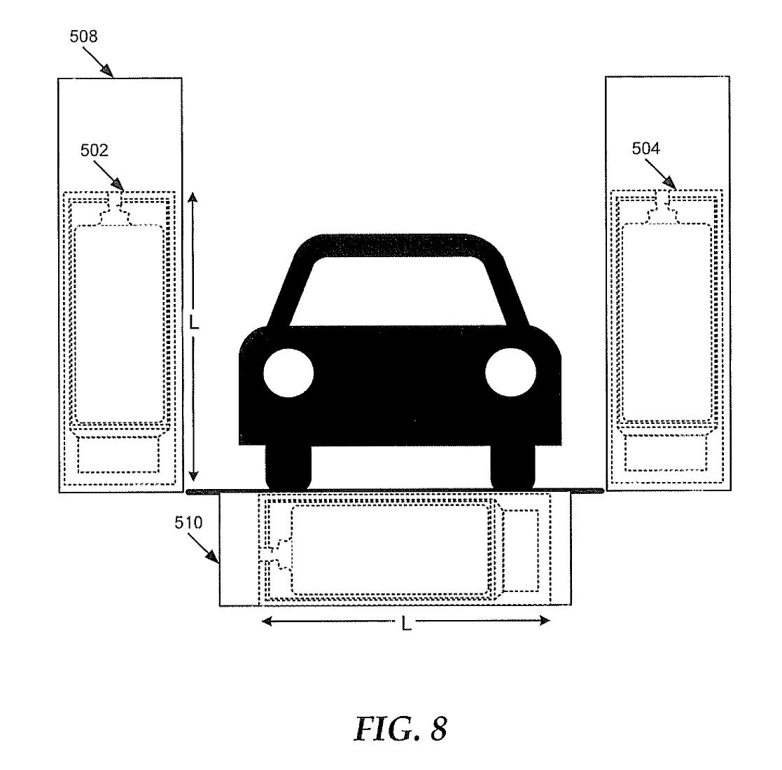

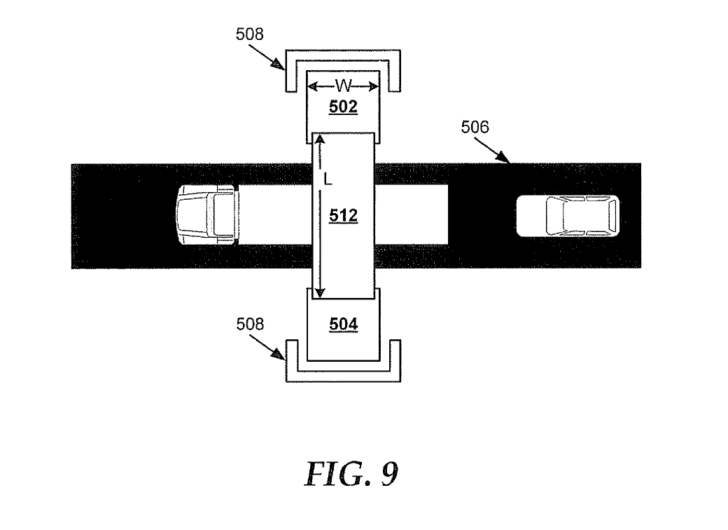

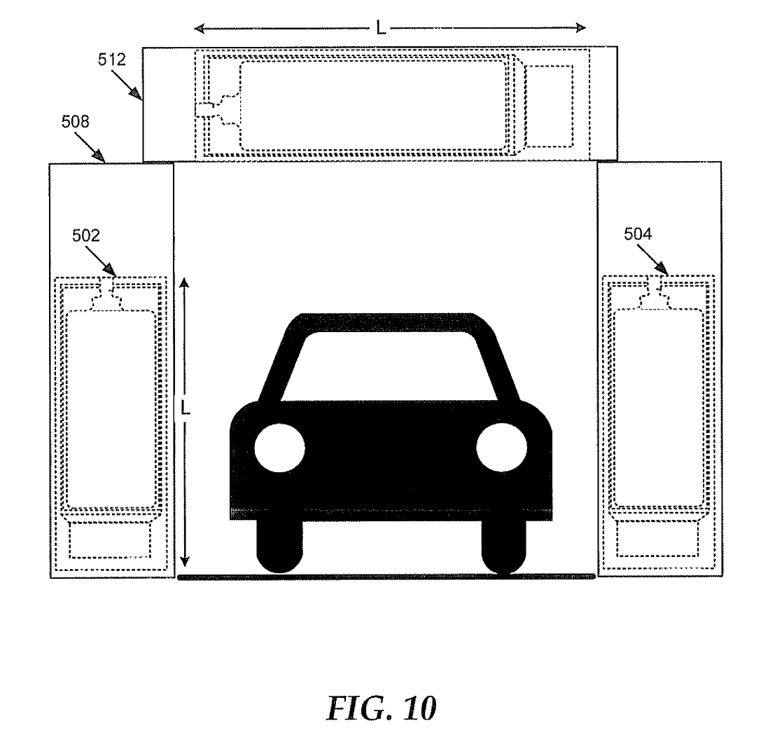

In another example, all or part of a radiation detector can be placed at an elevation that is lower than the radiation detectors 502 and 504. For instance, all or part of a radiation detector 510, shown in an end view in FIG. 7 and in a side view in FIG. 8, such as all or part of the scintillating material, can be partially beneath the road 506. As illustrated in FIG. 8, a length of the radiation detector 510 can be substantially perpendicular to a length of the radiation detector 502. In still another example, as illustrated in FIGS. 9 and 10, all or part of a radiation detector 512, such as all or part of the scintillating material, can be placed at an elevation that is higher than the radiation detectors 502 and 504. As illustrated in FIG. 10, a length of the radiation detector 512 can extend substantially perpendicular to a length of the radiation detectors 502 and 504. Those skilled in the art will recognize that various combinations of radiation detectors on a side of a passageway, above a passageway, beneath a passageway, or any combination thereof, may be used, and that the radiation detectors can be staggered, aligned, or any combination thereof.

In an illustrative embodiment, a collimator 508 can be placed near a radiation detector, such as the radiation detectors 502 and 504. The collimator 508 can include a shape and material suitable to substantially prevent neutrons, gamma radiation, or any combination thereof, not emitted within the passageway from being received by a radiation detector. In other embodiments, where gamma ray-induced electrical pulses are not desired, an absorber that includes lead, another suitable gamma ray absorbing material, or any combination thereof, can be placed near a radiation detector.

Continuing with the method illustrated in FIG. 4, at block 402, a carrier, such as a person, a passenger vehicle, a cargo vehicle, a watercraft, or another carrier, is passed by a radiation detector of the plurality of radiation detectors. Moving to block 404, a pulse analyzer can determine a shape of an electrical pulse output by the radiation detector passed by the carrier. In an illustrative embodiment, as illustrated in FIG. 5, more than one radiation detector can communicate with a pulse analyzer 520 and pulse counter 530. In another embodiment, a radiation detector can communicate with a separate pulse analyzer, and more than one pulse analyzer can communicate with a pulse counter, such as a pulse counter within a certain distance of the radiation detector. Other combinations and configurations of pulse analyzers and pulse counters are possible. A pulse analyzer, pulse counter, or any combination thereof, can be configured to associate an electrical pulse with a particular radiation detector, a time, or any combination thereof, such that neutron-induced pulses can be traced to their sources for identification of carriers likely to possess radioactive material.

Proceeding to decision node 406, the pulse analyzer determines whether the electrical pulse corresponds to a neutron-induced electrical pulse. For instance, the pulse analyzer can determine whether the electrical pulse corresponds to a neutron-induced pulse based on a shape of the electrical pulse. If not, such as when the pulse analyzer may determine that the electrical pulse corresponds to a gamma ray-induced electrical pulse or a noise-induced electrical pulse, the method can continue to block 408, and the pulse analyzer can send an indicator of a non-neutron pulse to a pulse counter. The method can then advance to decision node 416.

Conversely, if the pulse analyzer determines, at decision node 406, that the electrical pulse corresponds to a neutron-induced electrical pulse, the method can move to block 410, and the pulse analyzer can send an indicator of a neutron-induced electrical pulse to the pulse counter. Proceeding to decision node 412, the pulse counter, the pulse analyzer, or another device, can determine whether a target number of neutron-induced electrical pulses has been counted during a period of time. If so, the method can continue to block 414, and a radioactive material alert can be activated. For instance, if 2 to 5 neutrons are detected by a radiation detector, or by radiation detectors within a certain distance, over approximately 1 second, then the alert can be activated.

Moving to decision node 416, the pulse analyzer can determine whether there is another electrical pulse to be analyzed. If so, the method can return to decision node 406. Otherwise, the method can terminate at 418.

In accordance with particular embodiments and structure disclosed herein, a radiation detector is provided that includes a scintillator having a scintillating material to produce scintillation light in response to receiving neutrons. The scintillating material extends over a length greater than approximately 1.1 meters. In a particular embodiment, the radiation detector can include a liquid or gel scintillating material, such as a material including ⁶Li or ¹⁰B, in an amount greater than 11 liters. In an illustrative embodiment, such a radiation detector can be placed on a side of a passageway to detect radioactive material transported by a carrier passing the radiation detector.

Whereas single-phase, single crystal scintillators have been used to detect radioactive materials, the monolithic crystals used in such scintillators have been considered large at a length of 16 inches. This is shorter than a height of the cargo space of many transporters, such as people, cars, trucks, and other carriers. The embodiments of the radiation detector disclosed herein are less expensive and more effective to receive neutrons from the cargo space of such carriers. In another embodiment, several single crystals within the same radiation detector housing can be used.

Use of a scintillating material, as disclosed with respect to particular embodiments that includes ⁶Li or ¹⁰B enables a radiation detector to be scaled to various heights without necessarily using increasing dimensions of a monolithic scintillating compound, such as a single-phase, single crystal. For instance, a particular concentration of ⁶Li or ¹⁰B within a medium can provide scintillating properties sufficient for the applications disclosed herein. For instance, a ⁶Li molar concentration of 0.72 mol/L in a PXE solvent or a ¹⁰B molar concentration of 0.3 mol/L in a LAB solvent can provide sufficient interactions with neutrons to generate secondary particles. P-Terphenyl, PPO or another material can be within the LAB solvent in an amount of from approximately 1% by weight to approximately 5% by weight and provide sufficient scintillation light in response to the secondary particles. After reading this specification, skilled artisans will appreciate that the particular molar concentration can be varied as needed or desired for a particular application.

Nonetheless, the size of the scintillating material poses some challenges. For instance, a scintillator including a liquid or gel material, as disclosed herein, can contain greater than 11 liters of the scintillating material. Such quantities of liquid or gel scintillating materials typically do not act as uniform scintillators, as crystals or other solids typically do. This is particularly true when the scintillating material experiences temperature fluctuations, as it is likely to do in outdoor applications, such as the radioactive material detection applications disclosed herein. Thus, temperature regulation, pressure regulation, or a combination thereof, may be used to help maintain substantial uniformity in electrical pulses output by a radiation detector containing the quantities of liquid or gel scintillating material disclosed herein. Temperature regulation and calibration of electrical pulses, as disclosed herein, provide the added benefit of allowing the radiation detection system to be used outdoors, in nearly any climate.

Many different aspects and embodiments are possible. Some of those aspects and embodiments are described below. After reading this specification, skilled artisans will appreciate that those aspects and embodiments are only illustrative and do not limit the scope of the present invention. Additionally, those skilled in the art will understand that some embodiments that include analog circuits can be similarly implemented using digital circuits, and vice versa.

According to a first aspect, a radiation detector can include a scintillator having a scintillating material to produce scintillation light in response to receiving neutrons. The scintillating material can extend over a length greater than approximately 1.1 meters.

In an embodiment of the first aspect, the scintillating material can include ⁶Li or ¹⁰B. For instance, the scintillating material can include a liquid scintillating material or a gel scintillating material. The liquid or gel scintillating material can be contained within a cell that is longer than approximately 1.1 meters.

In another embodiment of the first aspect, the liquid or gel scintillating material can include a ¹⁰B concentration from approximately 0.1% by mass to approximately 10% by mass. In another embodiment of the first aspect, the liquid or gel scintillating material can include a ⁶Li concentration from approximately 0.1% by mass to approximately 10% by mass

In another embodiment of the first aspect, the liquid or gel scintillating material can include a lithium nitrate material, a lithium salicylate material or a trimethyl borate material. In a further embodiment of the first aspect, the liquid or gel scintillating material can include an organic solvent. For example, the organic solvent includes an aromatic compound, such as a 1-phenyl-1-xylyl ethane or a linear alkyl benzene.

In another embodiment of the first aspect, the scintillator can include greater than approximately 11 liters of the liquid or gel scintillating material.

In another embodiment of the first aspect, the scintillator can be configured to produce scintillation light in response to receiving neutrons when the scintillating material is at a temperature from approximately −40° C. to approximately +50° C. In another embodiment of the first aspect, an electrical pulse output by the radiation detector in response to the scintillation light can have a maximum peak shift uncertainty from approximately 0.1% to approximately 4% when a region to be analyzed by the radiation detector is at a temperature from approximately −40° C. to approximately +50° C.

In another embodiment of the first aspect, the radiation detector can include a temperature control system to measure a temperature of the scintillating material and to heat or cool the scintillating material to approximately a target temperature. In another embodiment of the first aspect, the radiation detector can include a pressure control system to measure a pressure of the scintillating material and to increase or decrease the pressure to approximately a target pressure. For instance, the pressure control system can include a bellows.

In another embodiment of the first aspect, a photosensor coupled to the scintillator includes a calibration system to calibrate the electrical pulse based on a pressure, a temperature, or any combination thereof, of the scintillating material.

In another embodiment of the first aspect, the scintillating material can include a polymer scintillating material, such as polyvinyltoluene, polystyrene, or polymethylmethacrylate.

In another embodiment of the first aspect, the scintillating material is configured to produce scintillation light in response to receiving gamma radiation.

In another embodiment of the first aspect, the radiation detector can include a photosensor to output an electrical pulse in response to receiving scintillation light from the scintillator. The photosensor can be optically coupled to the scintillator. The radiation detector can also include a pulse analyzer to identify the electrical pulse as corresponding to a gamma ray-induced electrical pulse or to a neutron-induced electrical pulse, based on a shape of the electrical pulse.

In another embodiment of the first aspect, the scintillating material can have a width greater than or equal to approximately 0.01 meters. For example, the scintillating material can have a width greater than or equal to approximately 0.1 meters.

According to a second aspect, a radiation detection system can include a plurality of radiation detectors including a first radiation detector and a second detector placed on opposing sides of a passageway. Each detector wither the plurality of radiation detectors can include a scintillator having a scintillating material to produce scintillation light in response to receiving neutrons, and can provide a detection region that is greater than approximately 1.1 meters.

In an embodiment of the second aspect, the detection region can extend to a height of greater than approximately 2 meters, such as a height of greater than approximately 3 meters.

In another embodiment of the second aspect, the radiation detection system can include a pulse analyzer to receive electrical pulses from the first and second radiation detectors and to identify each electrical pulse as corresponding to a gamma ray-induced electrical pulse or to a neutron-induced electrical pulse, based on a shape of the electrical pulse.

In another embodiment of the second aspect, each detector within the plurality of radiation detectors is configured to output an identifiable electrical pulse in response to receiving neutrons or in response to receiving gamma rays, when the scintillating material is at a temperature from approximately −40° C. to approximately +50° C.

In another embodiment of the second aspect, the radiation detection system can include another radiation detector that is at an elevation that is higher than the first and second radiation detectors. In another embodiment of the second aspect, the radiation detection system can include an additional radiation detector that is at an elevation that is lower than the first and second radiation detectors. A portion of the additional radiation detector can be beneath a surface of the passageway.

In another embodiment of the second aspect, the radiation detection system can include a collimator adjacent to a particular radiation detector within the plurality of radiation detectors. The collimator may substantially prevent neutrons, gamma radiation, or any combination thereof, emitted by a source outside the passageway from being received by the particular radiation detector.

According to a third aspect, a method can include providing a first radiation detector on a first side of a passageway and a second detector on a second side of the passageway. Each of the first and second radiation detectors can include a scintillator including a scintillating material to produce scintillation light in response to receiving neutrons. Each of the first and second radiation detectors provides a detection region that is greater than approximately 1.1 meters. The method can also include detecting a radioactive material within a carrier passing by the first and second radiation detectors, based on an output of a first photosensor included in the first radiation detector, a second photosensor included in the second radiation detector, or any combination thereof.

In an embodiment of the third aspect, the radioactive material can include a plutonium material or a uranium material.

In another embodiment of the third aspect, at least one of the first side of the first radiation detector and a second side of the second radiation detector extends along a plane substantially parallel or substantially perpendicular to the passageway.

In another embodiment of the third aspect, the method can include measuring a temperature of the scintillating material and heating or cooling the scintillating material to a target temperature. In another embodiment of the third aspect, the method can include measuring a pressure of the scintillating material and increasing or decreasing the pressure of the scintillating material to a target pressure.

In another embodiment of the third aspect, the method can include measuring a pressure, a temperature, or any combination thereof, of the scintillating material, and adjusting the electrical pulse based on the pressure, the temperature, or any combination thereof.

In another embodiment of the third aspect, the method can include determining whether electrical pulses output from the first radiation detector and the second radiation detectors correspond to a neutron-induced electrical pulse. The method can also include sending a neutron indicator to a counter when an electrical pulse corresponds to a neutron-induced pulse and activating a radioactive material alert when the counter counts 2 to 5 neutrons during approximately 1 second.

In another embodiment of the third aspect, the method can include sending a gamma ray indicator to the counter when an electrical pulse corresponds to a gamma ray-induced electrical pulse.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A radiation detector comprising a scintillator including a scintillating material to produce scintillation light in response to receiving targeted radiation, wherein the scintillating material extends over a length greater than approximately 1.1 meters.

2. The radiation detector of claim 1, wherein the scintillating material includes ⁶Li or ¹⁰B.

3. The radiation detector of claim 2, wherein the scintillating material includes a liquid scintillating material or a gel scintillating material.

4. (canceled)

5. The radiation detector of claim 3, wherein the scintillating material includes a ¹⁰B concentration from approximately 0.1% by mass to approximately 10% by mass.

6. The radiation detector of claim 3, wherein the scintillating material includes a ⁶Li concentration from approximately 0.1% by mass to approximately 10% by mass.

7. The radiation detector of claim 3, wherein the scintillating material includes a lithium nitrate material, a lithium salicylate material, or a trimethyl borate material.

8. The radiation detector of claim 7, wherein the scintillating material includes an organic solvent.

9. The radiation detector of claim 8, wherein the organic solvent includes an aromatic compound.

10. (canceled)

11. The radiation detector of claim 3, wherein the scintillator includes greater than approximately 11 liters of the scintillating material.

12-21. (canceled)

22. The radiation detector of claim 1, further comprising:
a photosensor to output an electrical pulse in response to receiving scintillation light from the scintillator, wherein the photosensor is optically coupled to the scintillator; and
a pulse analyzer to identify the electrical pulse as corresponding to a gamma ray-induced electrical pulse or to a neutron-induced electrical pulse, based on a shape of the electrical pulse.

23-24. (canceled)

25. A radiation detection system comprising:
a plurality of radiation detectors including a first radiation detector and a second detector placed on sides of a passageway, wherein each detector within the plurality of radiation detectors:
includes a scintillator including a scintillating material to produce scintillation light in response to receiving targeted radiation; and
provides a detection region that is greater than approximately 1.1 meters.

26. The radiation detection system of claim 25, wherein the detection region extends to a height of greater than approximately 2 meters.

27-29. (canceled)

30. The radiation detection system of claim 25, further comprising another radiation detector that is at an elevation that is higher than the first and second radiation detectors.

31-32. (canceled)

33. The radiation detection system of claim 25, further comprising a collimator adjacent to a particular radiation detector within the plurality of radiation detectors.

34. A method comprising:
providing a first radiation detector on a first side of a passageway and a second radiation detector on a second side of the passageway, wherein each detector within the first and second radiation detectors:
includes a scintillator including a scintillating material to produce scintillation light in response to receiving targeted radiation; and
provides a detection region that is greater than approximately 1.1 meters; and
detecting a radioactive material within a carrier passing by the first and second radiation detectors, based on an output of a first photosensor included in the first radiation detector, a second photosensor included in the second radiation detector, or any combination thereof.

35-37. (canceled)

38. The method of claim 35, further comprising measuring a temperature of the scintillating material and heating or cooling the scintillating material to a target temperature.

39. The method of claim 35, further comprising measuring a pressure of the scintillating material and increasing or decreasing the pressure of the scintillating material to a target pressure.

40. The method of claim 35, further comprising measuring a pressure, a temperature or any combination thereof, of the scintillating material, and adjusting the electrical pulse based on the pressure, the temperature or any combination thereof.

41. The method of claim 35, further comprising:
determining whether electrical pulses output from the first radiation detector and the second radiation detectors correspond to neutron-induced electrical pulses;
sending a neutron indicator to a counter when an electrical pulse corresponds to a neutron-induced pulse; and
activating a radioactive material alert when the counter counts 2 to 5 neutrons during approximately 1 second.

42. (canceled)
